(19) United States
(12) Patent Application Publication
(10) Pub. No.: US 2026/0219110 A1
(43) Pub. Date: Jul. 30, 2026

(54) Fourier Transform Spectrometr

(71) Applicant: SKM INSTRUMENTS, LLC, Centennial, WY (US)

(72) Inventors: Keith Carron, Centennial, WY (US); Mark Watson, Laramie, WY (US); Shane Buller, Laramie, WY (US)

(21) Appl. No.: 19/148,614

(22) PCT Filed: Jan. 16, 2024
(86) PCT No.: PCT/US2024/011713

§ 371 Date: Jul. 16, 2025

Related U.S. Application Data
(60) Provisional application No. 63/439,230, filed on Jan. 16, 2023.
(60) Provisional application No. 63/463,597, filed on May 3, 2023.
(60) Provisional application No. 63/529,612, filed on Jul. 28, 2023.
(60) Provisional application No. 63/601,080, filed on Nov. 20, 2023.

(51) Int. Cl. G01J 3/45; G01J 3/28; G01J 3/44

(52) U.S. Cl. CPC G01J 3/45; G01J 3/4406; G01J 3/4412; G01J 2003/283

(57) ABSTRACT

A Fourier Transform spectrometer including an interferometer is provided. In one embodiment, the FT spectrometer comprises an excitation light source, a beam splitter adapted to separate a metrology signal from the excitation light source, and direct the metrology signal through an interferometer to a metrology detector. The FT spectrometer is further adapted to receive a spectroscopy signal from a sample and pass the spectroscopy signal through the interferometer to a spectrometer detector. Methods of correction for motion of a mirror of the interferometer are provided. Further, a Total Spectroscopy approach including a spectroscopy signal including Raman scattering, fluorescence, and near infrared absorption components is also provided.

### CROSS-REFERENCE TO RELATED APPLICATIONS

This application claims the benefit of U.S. provisional application No. 63/439,230, filed Jan. 16, 2023, U.S. Provisional application No. 63/463,597 filed May 3, 2023, U.S. provisional patent application No. 63/529,612 filed Jul. 28, 2013, and U.S. provisional patent application No. 63/601,080 filed Nov. 20, 2023, each application of which is hereby incorporated by reference as though fully set forth herein.

### BACKGROUND

### Field

The instant disclosure relates to relates to a Fourier Transform (FT) Spectrometer. In particular, the instant disclosure relates to an FT Spectrometer including an interferometer configured to be a very small device with many applications, including wearable devices.

### Background

A Fourier Transform Spectrometer including an interferometer is provided.

### BRIEF SUMMARY

A Fourier Transform spectrometer including an interferometer is provided. In one embodiment, the FT spectrometer comprises an excitation light source, a beam splitter adapted to separate a metrology signal from the excitation light source and direct the metrology signal through an interferometer to a metrology detector. The FT spectrometer is further adapted to receive a spectroscopy signal from a sample and pass the spectroscopy signal through the interferometer to a spectrometer detector. Methods of correction for motion of a mirror of the interferometer are provided. Further, a Total Spectroscopy approach including a spectroscopy signal including Raman scattering, fluorescence, and near infrared absorption components is also provided.

The foregoing and other aspects, features, details, utilities, and advantages of the present invention will be apparent from reading the following description and claims, and from reviewing the accompanying drawings.

### BRIEF DESCRIPTION OF THE DRAWINGS

FIG. 1 shows an embodiment of a Fourier Transform (FT) Raman spectrometer.

FIG. 2 shows another example embodiment of an FT spectrometer.

FIG. 3 shows an example of possible imperfections in a signal generated within an interferometer due to imperfections in mirror movement and/or changes in ambient conditions, such as changes in temperature or light conditions.

FIG. 4 further elaborates on problems that may be introduced in an FT spectrometer including an interferometer due to mirror motion imperfections and/or variations in ambient conditions.

FIG. 5 is a graph showing an example of a method to correct for imperfect motor motion, thermal expansion or contraction of component(s) within the spectrometer (e.g., due to changes in ambient conditions), and/or changes in a laser or other light source wavelength.

FIG. 6 is a graph showing an example of a corrected FT signal resulting from using the method of correction described with reference to FIG. 5.

FIGS. 7A through 7C shows a further example of an implementation to correct for imperfect mirror motion in a small scalable FT spectrometer.

FIG. 8 shows a pair of graphs showing more detail of an example of a scalable FT spectrometer with an imperfect mirror motion.

FIG. 9 shows a graph showing additional detail of an example of a scalable FT spectrometer with an imperfect mirror motion.

FIG. 10 shows an example of a scalable FT spectrometer with an imperfect mirror motion corrected by the implementation of a post-processing method of correction.

FIGS. 11A through 11C show graphs showing the effect of imperfect mirror motion and its effect on the calibration of a FT spectrum.

FIG. 12 shows an example of calibration with a scalable FT spectrometer.

FIG. 13 is an example of combinations of multiple spectroscopic signals into a Total Spectroscopy signal.

FIG. 14 is another example of an FT spectrometer adapted to produce a Total Spectroscopy signal that is a combination of at least a Raman spectrum, a fluorescence spectrum, and a NIR absorption spectrum.

FIGS. 15A through 15D show an example of an implementation of VCSEL excitation to produce spatial information about a sample.

FIG. 16 is another example of an implementation of an FT spectrometer comprising a relatively large area excitation pattern adapted to produce spatial averaging and lower power density over the sample.

FIG. 17 shows spectra obtained using a microlens array, a ball lens, and a convex lens to produce a Raman spectrum.

FIG. 18 is an example of an implementation of a scalable FT spectrometer for rejection of interferences from ambient light conditions.

FIG. 19 shows another example implementation of a scalable FT spectrometer for rejection of interferences.

FIG. 20 is another example of an implementation of a device to operate at long wavelengths above 900 nm.

FIG. 21 shows two example implementations of actuators that may be used to move a component of an FT spectrometer, such as a moving mirror of an interferometer of an FT spectrometer.

FIGS. 22A through 22B show three example embodiments of actuators that may be used to move a component of an FT spectrometer, such as a moving mirror of an interferometer of an FT spectrometer.

FIGS. 23A and 23B show two examples of actuators that may be used to move a component of an FT spectrometer, such as a moving mirror of an interferometer of an FT spectrometer.

### DETAILED DESCRIPTION

The following description of the invention is provided as an enabling teaching of the invention in its best, currently known embodiment. To this end, those skilled in the relevant art will recognize and appreciate that many changes can be made to the various aspects of the invention described herein, while still obtaining the beneficial results of the present invention. It will also be apparent that some of the desired benefits of the present invention can be obtained by selecting some of the features of the present invention without utilizing other features. Accordingly, those who work in the art will recognize that many modifications and adaptations to the present invention are possible and can even be desirable in certain circumstances and are a part of the present invention. Thus, the following description is provided as illustrative of the principles of the present invention and not in limitation thereof.

As used throughout, the singular forms “a,” “an” and “the” include plural referents unless the context clearly dictates otherwise. Thus, for example, reference to “a” component can include two or more such components unless the context indicates otherwise. Also, the words “proximal” and “distal” are used to describe items or portions of items that are situated closer to and away from, respectively, a user or operator such as a surgeon. Thus, for example, the tip or free end of a device may be referred to as the distal end, whereas the generally opposing end or handle may be referred to as the proximal end.

All directional references (e.g., upper, lower, upward, downward, left, right, leftward, rightward, top, bottom, above, below, vertical, horizontal, clockwise, and counterclockwise) are only used for identification purposes to aid the reader's understanding of the present invention, and do not create limitations, particularly as to the position, orientation, or use of the invention. Joinder references (e.g., attached, coupled, connected, and the like) are to be construed broadly and may include intermediate members between a connection of elements and relative movement between elements. As such, joinder references do not necessarily infer that two elements are directly connected and in fixed relation to each other.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

As used herein, the terms “optional” or “optionally” mean that the subsequently described event or circumstance may or may not occur, and that the description includes instances where said event or circumstance occurs and instances where it does not.

The term “substantially” as used herein may be applied to modify any quantitative representation which could permissibly vary without resulting in a change in the basic function to which it is related.

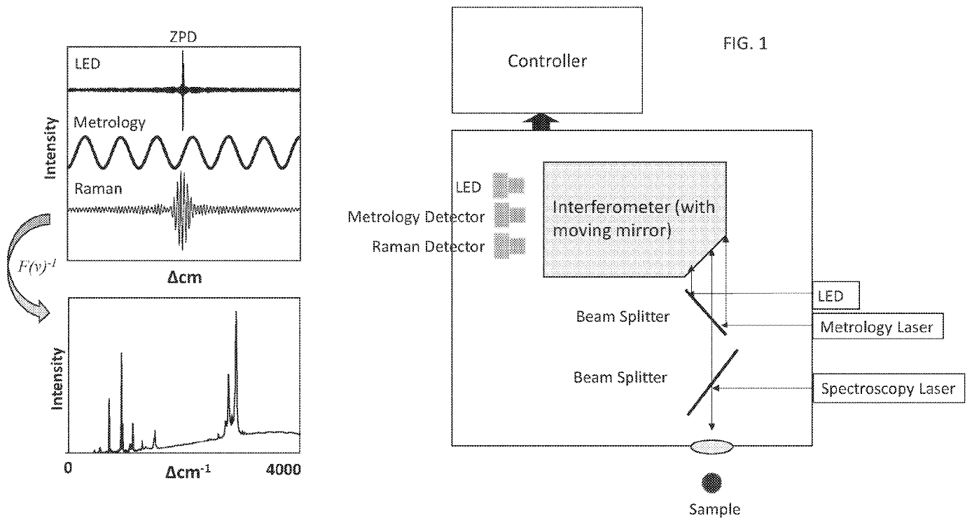

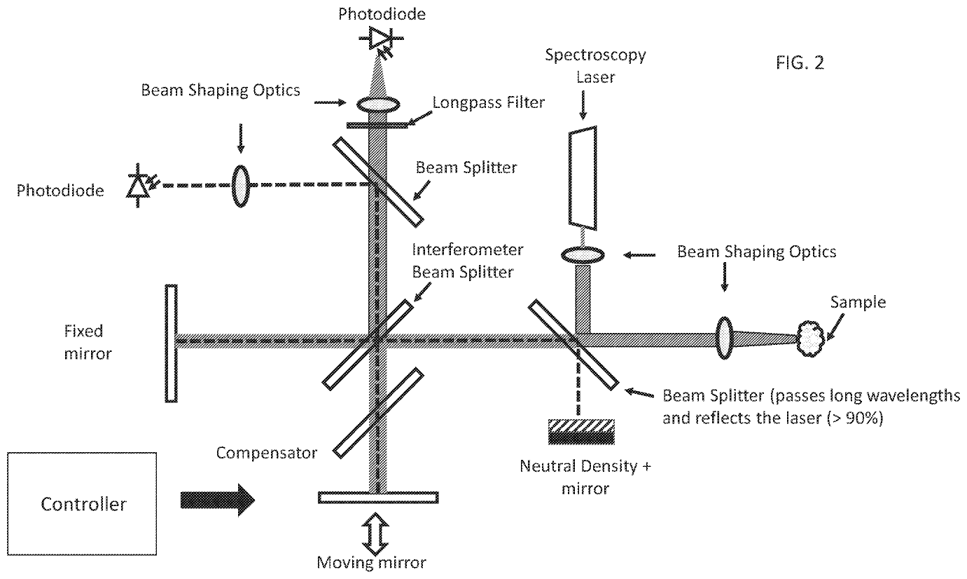

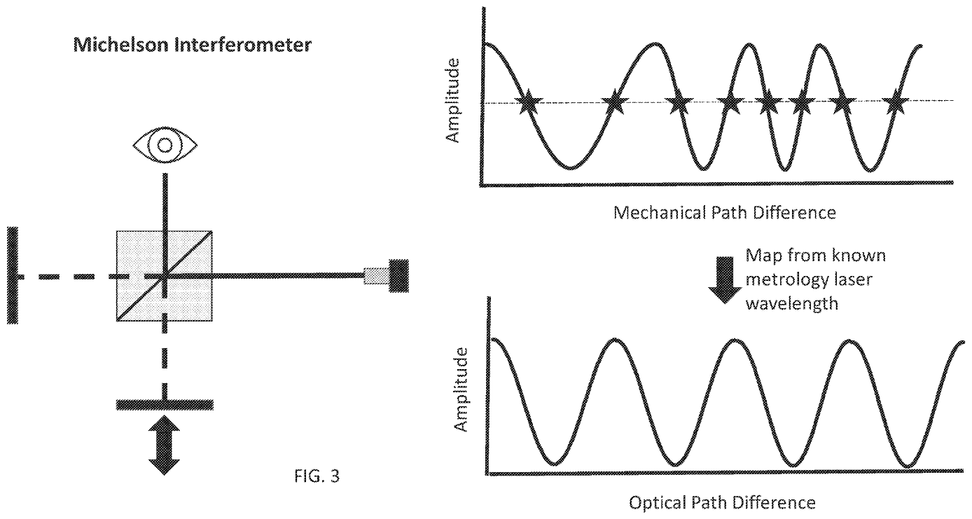

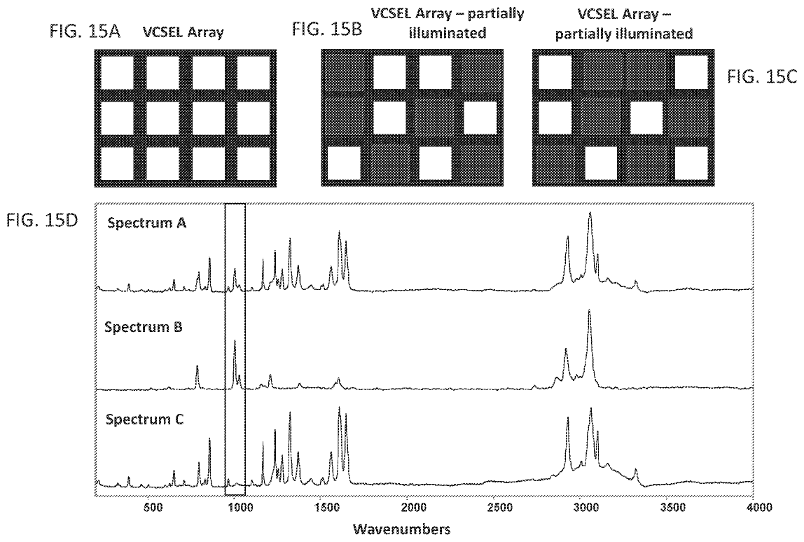

Various embodiments are provided in which individual concepts, components, and techniques are described that may be combined in further embodiments. The contemplated embodiments are not limited to the individual embodiments provided herein but rather include variations of the concepts, components, and techniques provided. The processes such as those shown and described with reference to FIGS. 3-19D may be used in an FT spectrometer, such as but not limited to the interferometer embodiments shown in FIGS. 1 and 2. Further, the components, such as shown in FIGS. 15-17, 19D, 21A-21C, 22A, and 22B could also be used in any spectrometer, such as but not limited to an FT spectrometer such as shown in FIGS. 1 and 2.

FIG. 1 shows an embodiment of a Fourier Transform (FT) Raman spectrometer. The spectrometer comprises a spectroscopy laser adapted to provide an excitation light signal to excite a sample and produce a spectroscopy signal (e.g., Raman scattering, fluorescence, and/or near infrared (NIR) absorption) from the sample. The spectroscopy laser (e.g., a Raman laser) is shown directing the excitation light signal towards the sample with a first dichroic beam splitter which sends a relatively large percentage of the beam to the sample. In one embodiment, for example, less than 5% of the laser excitation light signal leaks through the dichroic beam splitter. The first dichroic beam splitter also permits longer wavelengths, such as the spectroscopy signal (e.g., a Raman scattering signal, a fluorescence signal, and/or a NIR absorption signal), to pass through to an interferometer. A second laser called the metrology laser produces a metrology light signal that is directed into the interferometer. The purpose of the metrology laser is two-fold. First, the metrology laser is used to schedule the sampling of the spectroscopy signal (e.g., Raman scattering signal) and to ensure that sampling is greater than two times the frequency of the Raman signal. This is the Nyquist condition. Second, the principle of FT spectroscopy is that a moving mirror within the interferometer will produce an interferogram that has its abscissa as distance between two mirrors. The accuracy of this distance dictates the accuracy of the spectrum produced by the FT algorithm. A quasi-monochromatic source like a laser will produce a sinusoidal pattern that has maxima at precisely the wavelength of the laser and therefore is a standard for the distance between the mirrors. The third source that an FT spectrometer might utilize is a broadband source, such as a “white light” or other broadband source, to produce a large signal when the mirrors are exactly the same distance apart. This is shown in FIG. 1 as an LED source to produce the broadband signal.

In the embodiment shown in FIG. 1, for example, the interferometer may comprise a Michelson design with an approximately 50 to approximately 50% beam splitter placed between a moving mirror and fixed mirror. The source signals (spectroscopy signal, metrology light signal, and/or broadband signal) are introduced to the beam splitter. The beam splitter sends one portion of the source signals to the fixed mirror and the other portion of the source signals to the moving mirror. This produces an interference pattern determined by the distance between the mirrors and the wavelength of the sources. The interference pattern (interferogram) is projected onto transducers (e.g., photodetectors) to produce an electrical signal to record the interferogram. In the example shown in FIG. 1, for example, three detectors are shown for the three sources.

In this embodiment, the spectrometer comprises three detectors that provide respective detected signals. An LED detector produces an LED detection signal comprising a sharp peak at the Zero Path Difference (ZPD). This can be used by an FT algorithm that integrates the interferogram from 0 to infinity and this defines the signal at 0. The theory of FT states that a signal from a broad source will produce a large interferometer signal at the ZPD.

A metrology detector produces a metrology detection signal that is used to determine an Optical Path Difference (OPD), which can be used to correct for inaccuracy in the mechanical drive of the moving mirror. The theory of FT states that a sharp (monochromatic) signal will produce a continuous sinusoidal interferogram.

A spectroscopy detector (e.g., a Raman detector) produces a spectroscopy detected signal (e.g., a Raman detected signal) that is a combination of multiple sharp bands and therefore produces an interferogram that is a combination of the multiple sinusoidal signals at different frequencies.

When the FT algorithm is applied to these signals (intensity vs path difference) they produce a spectrum (intensity vs frequency). The FT algorithm in various implementations may be performed by a controller or other processor device and may include a Fast Fourier Transform (FFT) or Discrete Fourier Transform (DFT).

Calculations and correction algorithms are performed via a controller. The controller is a component of the FT spectrometer in one embodiment. In another embodiment, a controller is remotely connected to the FT spectrometer, such as wirelessly (e.g., Bluetooth, WiFi or other or wireless connection) or wired (e.g., USB or Lightning connection). A wearable device, for example, may be adapted to be wirelessly connectable to an external processor or controller, such as to a smart phone, tablet, laptop computer, personal computer, or other computing device. In one embodiment, for example, the FT spectrometer is adapted to send the interferograms (metrology and spectroscopic) to an Android device through Bluetooth. In this embodiment, there is a controller on the interferometer to create the waveform to control the motor and there will be a second wirelessly “controller” to perform the Fourier transform and correction/calibration methods.

FIG. 2 shows another example embodiment of an FT spectrometer. In this embodiment, the FT spectrometer comprises a spectroscopy laser source, but eliminates the broadband light source and the metrology light source shown in the FT spectrometer shown in FIG. 1. In the FT spectrometer shown in FIG. 2, the functionality of the broadband light source and the metrology light source shown in FIG. 1 is replaced with the spectroscopy light source.

The FT spectrometer also comprises a mirror and a filter (e.g., a neutral density filter). The mirror and neutral density filter are adapted to isolate, attenuate, and forward a small amplitude light signal from the spectroscopy laser that leaks through the dichroic beam splitter into the interferometer. This signal is used as a metrology signal from the spectroscopy laser source. In this embodiment, for example, the FT spectrometer is adapted to function without the requirement of a secondary metrology laser. The FT spectrometer also produces a metrology signal that is at the spectroscopy laser source frequency and this can be used to calibrate the spectroscopy signal.

In one embodiment, the mirror may be used without a filter to reflect the leakage portion of the spectroscopy light signal toward the interferometer as a metrology light signal where the signal is not needed to be attenuated or where the mirror is adapted to attenuate the leakage portion of the spectroscopy light signal. In one embodiment, for example, the surface of the “mirror” could be modified to reduce the reflectivity. For example, the “mirror” may comprise a glass plate, a bead blasted plate, a poorly reflecting metal surface, or even a slight misalignment of the optic or the detector. Also, the neutral density filter could be placed at or near the detector. In yet another example, the beam shaping optic could defocus the light on the detector.

In the embodiment of the FT spectrometer shown in FIG. 2, the FT spectrometer is adapted to use the leaked, attenuated portion of the spectroscopy laser light signal as a metrology laser. The laser signal generated by the spectroscopy laser source is directed to a first beam splitter. The first beam splitter reflects predominantly all of the spectroscopy laser signal toward the sample. The spectroscopy laser signal is focused onto the sample via one or more beam shaping optics, such as a lens. A small fraction of the spectroscopy laser signal, however, will pass through the first beam splitter toward the mirror and neutral density filter as shown in a dotted line pattern. The mirror and neutral density filter are used to attenuate the portion of the spectroscopy light signal that leaks through the first dichroic beam splitter via the neutral density filter and to reflect the attenuated light signal back to the first beam splitter via the mirror. The first dichroic beam splitter, in turn, reflects the attenuated leakage portion of the spectroscopy light signal into the interferometer. In the interferometer, an interferometer beam splitter divides the attenuated light signal between a fixed mirror and a moving mirror of the interferometer. The split attenuated light signal is then passed to a third beam splitter.

A compensator is used in some implementations, such as where the beam splitter has a surface that is coated to create the splitting of the light. In such an example, one arm of the interferometer has a longer optical distance due to the refractive index of the beam splitter material. In other words, the path of one arm is longer by n (refractive index) x the thickness of the beam splitter. Since the refractive index is also wavelength dependent, the difference in the distance of both arms changes with wavelength. In this example, the compensator can comprise the same material as the beam splitter.

The metrology signal path of the attenuated light signal is shown in this embodiment with a dotted path in FIG. 2. The last beam splitter in the system reflects this short laser wavelength and passes the longer wavelength spectroscopic signal. The laser metrology signal is then focused onto a metrology detector (e.g., a photodiode) via one or more beam shaping optics, such as a lens. In this particular embodiment, for example, the metrology detector comprises the photodiode pictured on the left of the interferometer. Similarly, the longer wavelength spectroscopic signal (shown by the grey solid path) is passed by the third and final beam splitter toward a long-pass filter and then is focused onto a spectroscopic detector via one or more beam shaping optics, such as a lens. In this embodiment, the spectroscopic detector comprises a second photodiode pictured on the top of the interferometer.

A controller is provided to perform one or more calculations or operations for the FT spectrometer. In one embodiment, for example, one or more calculations and correction are performed via a controller. The controller is a component of the FT spectrometer in one embodiment. In another embodiment, a controller is remotely connected to the FT spectrometer, such as wirelessly (e.g., Bluetooth, WiFi or other or wireless connection) or wired (e.g., USB or Lightning connection). A wearable device, for example, may be adapted to be wirelessly connectable to an external processor or controller, such as to a smart phone, tablet, laptop computer, personal computer, or other computing device. In one embodiment, for example, the FT spectrometer is adapted to send the interferograms (metrology and spectroscopic) to an Android device through Bluetooth. In this embodiment, there is a controller on the interferometer to create the waveform to control the motor and there will be a second wirelessly “controller” to perform the Fourier transform and correction/calibration methods

FIG. 3 shows an example of possible imperfections in a signal generated within an interferometer due to imperfections in mirror movement and/or changes in ambient conditions, such as changes in temperature or light conditions.

In one embodiment of an FT spectrometer, for example, a method for correcting a signal, such as for imperfections in the mirror and/or changes in ambient conditions, such as light conditions, is provided. In this embodiment, the method of correcting a light signal for mirror motion imperfections, for example, permits motor driven mirror motion that can be imperfect and low-cost compared to the current methods of, for example, air bearings to produce perfect mirror motion. This also enables scalable spectrometers that are able to make use of small and low-cost components that will produce imperfect motion.

Although FIGS. 1 and 2 show interferometers of an FT spectrometer that comprise a single fixed mirror and a single moving mirror, other implementations are also contemplated. A wishbone design interferometer that comprises two moving mirrors without a fixed mirror can also be used. In this design, for example, the fixed mirror of the interferometers shown in FIGS. 1 and 2 may be replaced with a moving mirror. Similarly, the spectrometers of FIGS. 1 and 2 may comprise a fixed mirror and a plurality of moving mirrors.

FIG. 3, for example, shows an example of an interferometer as a Michelson interferometer comprising a first, fixed mirror and a second, moving mirror. The interferometer receives an input light signal, such as described with reference to FIGS. 1 and 2 and generates an interferogram output signal that is directed to a detector.

In the top graph shown on the right side of FIG. 3, a mechanical path difference can be shown in the irregular, non-sinusoidal pattern shown. Changes in movement of the second, moving mirror or changes in componentry, such as due to temperature fluctuations, can provide an irregular signal.

In the bottom graph shown on the right side of FIG. 3, a uniform, sinusoidal pattern corresponding to a known light source (e.g., metrology laser source, spectroscopy laser source, broadband light source) can be used to map a plurality of data points from the irregular, non-sinusoidal pattern shown in the top graph to correct for the variations in mirror movement and/or ambient conditions. In FIG. 3, the top graph shows a mechanical path difference observed from an imperfect motor. The Optical Path Difference is the true location. In other words, the Optical Path Difference is the actual location of the motor determined by the sinewaves.

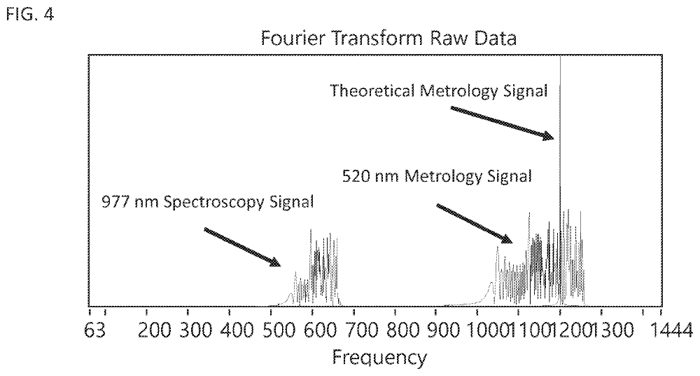

FIG. 4 further elaborates on problems that may be introduced in an FT spectrometer including an interferometer due to mirror motion imperfections and/or variations in ambient conditions.

FIG. 4 illustrates a problem with imperfect mirror motion. FIG. 4 shows the spectrum produced by a 520 nm VCSEL metrology laser and a signal produced from a 977 nm VCSEL laser. Both the metrology laser at 520 nm and the spectroscopic signal at 977 nm should theoretically be a single line since they are from a quasi-monochromatic source. The broad frequency range around each of these signals stems from an imperfect mirror motion produced at the moving mirror, such as via a voice coil acting as a motor used in one embodiment of an FT spectrometer. Voice coils, such as from small earphone speakers, represent one possibility to produce a scalable miniature FT spectroscopy system.

A second aspect of shown in FIG. 4 is that VCSELs (Vertical Cavity Surface Emitting Laser) can be used as one or more source for FT spectroscopy. VCSELs represent a low-cost, small-scale laser source that can have the line width and stability required to be a spectroscopy source (e.g., a Raman source) or a metrology laser.

The broadening of the signals is due to the convolution of the true interferograms, as if the mirror motion were perfect, and the imperfect motion of the mirror.

FIG. 5 is a graph showing an example of a method to correct for imperfect motor motion, thermal expansion or contraction of component(s) within the spectrometer (e.g., due to changes in ambient conditions), and/or changes in a laser or other light source wavelength. The correction may be particularly useful in a scalable FT spectrometer with imperfect mirror motion, such as due to small, relatively inexpensive components. In this embodiment, digital mapping of postprocessed data (e.g., metrology data) to an ideal sinewave calculated from the source signal (e.g., metrology laser light source) frequency.

FIG. 5 shows a graph of a typical metrology signal from an imperfect mirror motion in an FT spectrometer on the top of FIG. 5. Ideally, the metrology signal should be a perfect sinusoidal signal as illustrated in the bottom portion of FIG. 5. As discussed above with respect to FIGS. 3 and 4, the imperfect signal can be corrected by post processing detected data by taking evenly spaced data points from a perfect sinusoidal wave created by counting the number of peaks in the metrology interferogram and creating a sinusoidal wave that has the same number of peaks. The evenly spaced points are designated in the model sinusoidal signal and used map the imperfect signal from the imperfect mirror motion. This method corrects the metrology signal and corrects it to match the calculated sinusoidal signal.

The map is also applied to the spectroscopy signal and thereby corrects the spectroscopy signal for the imperfect mirror motion. This embodiment is useful to create a small scalable FT spectrometer that may suffer from imperfect mirror motion. It also will correct for changes in the interferometer that could occur due to environmental changes. An example would be temperature changes that lead to mechanical expansion of the interferometer materials. Temperature increases could increase the distance between the fixed and moving mirror. This would change the interferogram in an unpredictable fashion. This embodiment would similarly correct for those changes. If the scalable FT spectrometer were used as a wearable device, for example, it would be subject to these temperature changes due to body temperature and ambient temperatures.

As described above with respect to FIG. 3, an example method to correct for mirror motion imperfection is the following:
count the number of peaks in the metrology signal;
use the number of peaks to create an average frequency of peaks in the interferogram;
use this frequency to create a theoretical interferogram with a perfect sinusoidal pattern;
the peaks and valleys in the acquired interferogram and in the theoretical interferogram are located;
add or remove these distances from the acquired interferogram to force it to match the theoretical interferogram; and
use the same distances to map a spectroscopic interferogram to the theoretical interferogram thereby correcting it as well.

In one embodiment, for example, the metrology signal is sampled at 500 kHz as the mirror is moving back and forth. This could create 1 million data points during the forward motion of the mirror. The data received is for intensities and it seems like over time. But since the mirror is moving it can be converted to a distance instead of time. Since the motor is imperfect, the distance is not known accurately.

A correction is that optically the metrology laser produces peaks and valleys. By taking the total number of peaks in the imperfect metrology signal and create a uniform sinusoidal pattern we can calculate the distance from the imperfect metrology signal into the perfect waveform of our calculated sinusoidal pattern. The corrections can then also be applied to spectroscopy signal and thereby correcting it as well.

The calculations and correction are performed via a controller. The controller is a component of the FT spectrometer in one embodiment. In another embodiment, a controller is remotely connected to the FT spectrometer, such as wirelessly (e.g., Bluetooth, WiFi or other or wireless connection) or wired (e.g., USB or Lightning connection). A wearable device, for example, may be adapted to be wirelessly connectable to an external processor or controller, such as to a smart phone, tablet, laptop computer, personal computer, or other computing device. In one embodiment, for example, the FT spectrometer is adapted to send the interferograms (metrology and spectroscopic) to an Android device through Bluetooth. In this embodiment, there is a controller on the interferometer to create the waveform to control the motor and there will be a second wirelessly “controller” to perform the Fourier transform and correction/calibration methods.

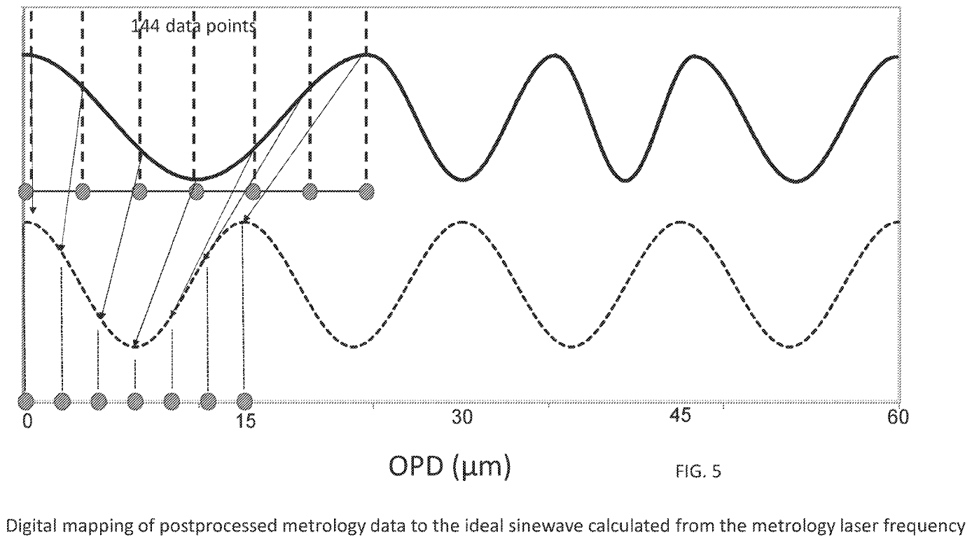

FIG. 6 is a graph showing an example of a corrected FT signal resulting from using the method of correction described with reference to FIG. 5.

The two signals, metrology and spectroscopic, shown in FIG. 4 should be sharp lines produced by the quasi-monochromatic lasers. FIG. 4, however, shows that the uncorrected signals are very broad signals, such as due to the imperfect mirror motion produced by a voice coil. When the method of post processing described in FIG. 5 is applied to this data the result is shown in FIG. 6. The broad spectral features shown in FIG. 4 collapse into the correct sharp lines shown in FIG. 6.

In this example, the x-axis shows data points. For an interferogram that is 100,000 points long, determined by the Analog to Digital Converter sampling rate and how fast the mirror is moving, the x-axis would go from 1 to 100,001. In a method for correcting, everything can be done in data points until the data is calibrated.

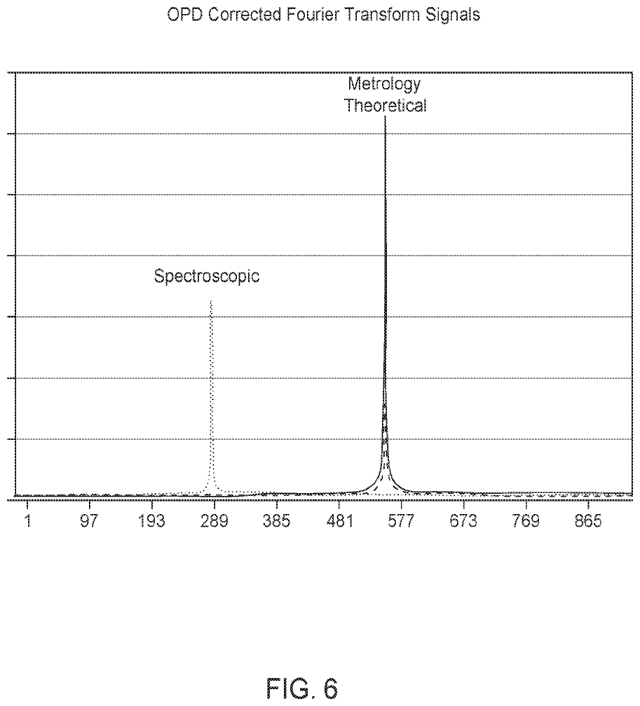

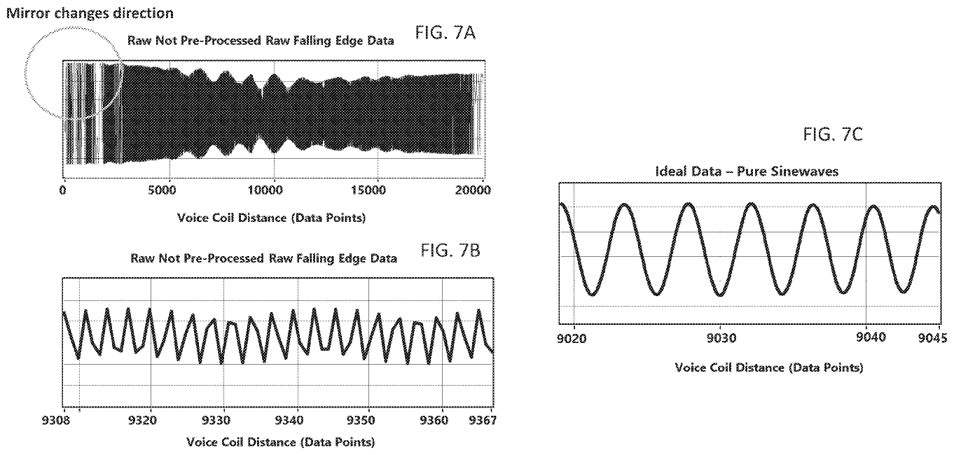

FIGS. 7A through 7C show a further example of an implementation to correct for imperfect mirror motion in a small scalable FT spectrometer.

FIGS. 7A through 7C are graphs showing a data set from an FT spectroscopic experiment to measure the spectrum of an LED spectroscopic source. In this example, the mirror motion is controlled with a voice coil. A sawtooth voltage waveform was applied to the voice coil to produce linear forwards and backwards motion. FIGS. 7A through 7C show the imperfections as the motor slows and stops to change the direction of its motion. Also illustrated is an imperfect metrology signal. The variation in intensity results from imperfect motion resulting in poor alignment of the interferometer. The variation in the distance between the peaks of the metrology signal is due to poor linear motion of the voice coil driving the moving mirror.

In this example, FIG. 7A shows actual data from an interferometer. The frequency distortions near the points where the mirror changes direction are evident (shown at the region highlighted by a circle) and the variations in the metrology signal are evident throughout the interferogram. FIG. 7B shows a small portion of the metrology signal and what should be sinusoidal waves are irregular sawtooth waves due to under sampling the interferogram. FIG. 7C shows a theoretical sinewave for comparison. In one embodiment, the portion of the data corresponding to where the mirror changes direction (the highlighted region) can be discarded from the data used to correct the metrology and spectroscopic signals for mirror motion and/or environmental changes due to its increased noise levels.

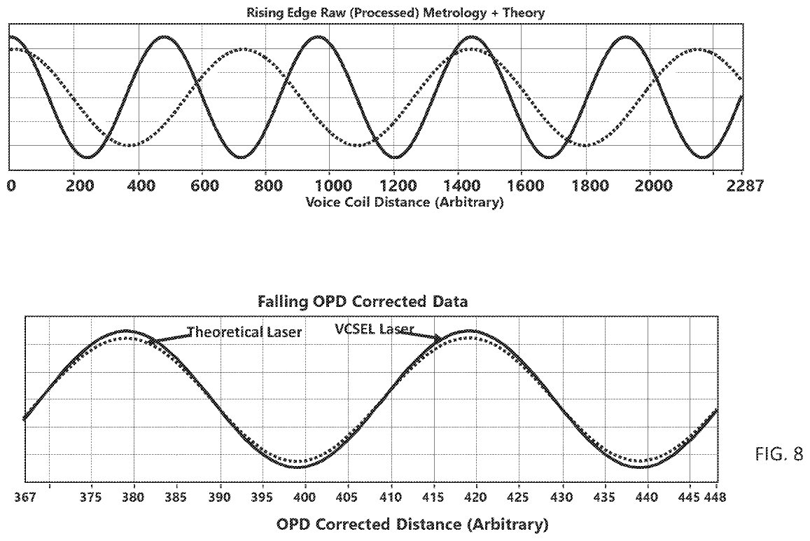

FIG. 8 includes a pair of graphs showing more detail of an example of a scalable FT spectrometer with an imperfect mirror motion.

The graphs shown in FIG. 8 elaborate on the data shown in FIGS. 7A through 7C. This subset of the data shown in FIGS. 7A through 7C illustrates the imperfect mirror motion in this voice coil driven spectrometer. The solid line is calculated from the total number of peaks in the metrology (dashed lines) interferogram. In this example, a portion of the rising edge of the sawtooth mirror drive waveform is shown. The total number of peaks in the metrology interferogram is 2077 and there are 1,000,000 data points. This frequency (2077/1000000) is used to create a theoretical, perfect sinusoidal wave shown as the dotted line. FIG. 8 illustrates the error (i.e., how far off the metrology signal is from the calculated signal) from the theoretical signal in the data subset. In this small subset of the interferogram it can be seen that the mirror is moving faster, producing a higher frequency sinewave than the calculated sinewave. These variations in the velocity of the mirror motion lead to a broadened spectrum as shown in FIG. 4.

FIG. 8 also shows that after application of the method described in FIG. 5 that the metrology data follow the exact frequency of the calculated interferogram. The method described in FIG. 5 can be used to correct both for the frequency of the data and the intensity of the data.

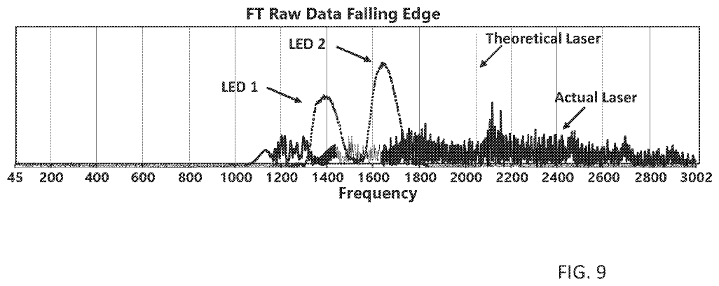

FIG. 9 shows a graph showing additional detail of an example of a scalable FT spectrometer with an imperfect mirror motion.

FIG. 9 illustrates the FT result of poor mirror motion in a small scalable FT spectrometer. FIG. 9 shows the FT of the data presented in FIGS. 7A through 7C. As in FIG. 4, the metrology signal is spread over a large range due to the large variability of the frequencies in the interferogram. In this example, spectroscopic signals were simulated using different LEDs as individual, simulated spectroscopic signals disposed at a simulated sample location. The interferogram of the two simulated spectroscopic signal from the LED sources was also collected and labeled as LED1 and LED2. They are distorted due to the poor mirror motion but are less spread out in frequency space than the metrology signal. This is due to the LED output forming a small burst of signal around the ZPD and are not subject to as much distortion over the longer mirror motion captured by the metrology laser. We calculate from component specification Full Width Half Maximum (FWHM) that the LED simulated spectroscopic signals are distorted by approximately 6%. In this particular example, a Marktech Optoelectronics Multichip emitter product number MTMD6788594SMT6 was used as the LED source for the simulated spectroscopic signal sources.

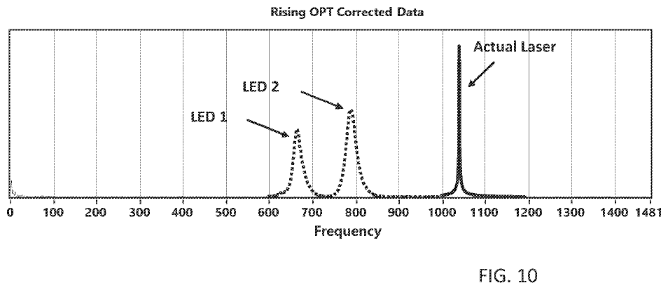

FIG. 10 shows an example of a scalable FT spectrometer with an imperfect mirror motion corrected by the implementation of a post-processing method of correction.

FIG. 10 illustrates the result of an implementation of the correction process outlined in FIG. 5. FIG. 9 shows this same data prior to the correction. FIG. 9 demonstrated that the poor mirror motion in a small scalable FT spectrometer can lead to false data when the FT algorithm is applied. FIG. 10 shows that the algorithm from FIG. 5 corrects the data leading to a proper sharp line for the metrology laser over the full distance of the mirror motion and also corrects the line shape and FWHM of the two LED sources representing a simulated spectroscopic source.

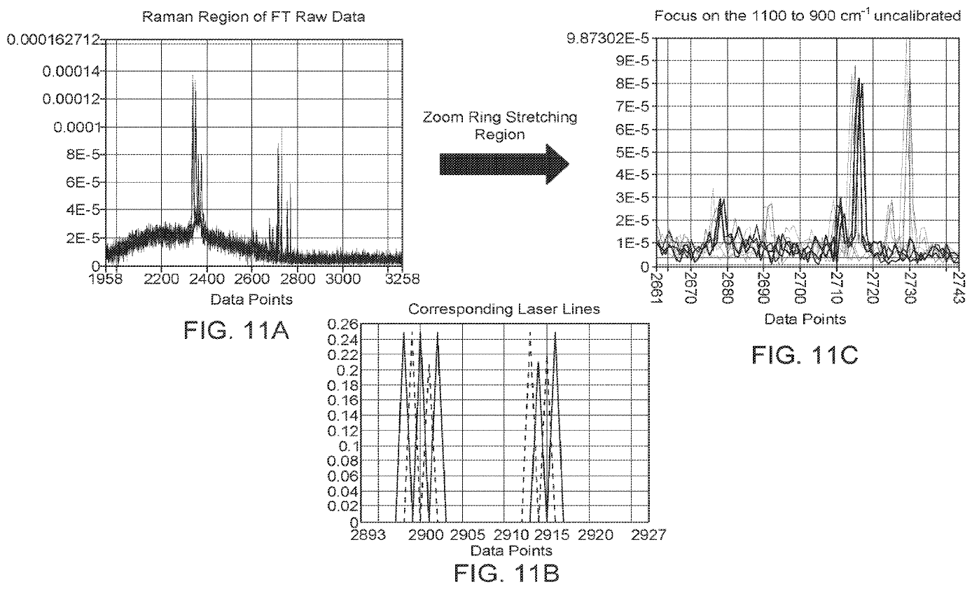

FIGS. 11A through 11C show graphs showing the effect of imperfect mirror motion and its effect on the calibration of a FT spectrum.

An alternative to FT spectroscopy is to use a dispersive optical element such as a diffraction grating. Gratings are significantly different from an FT spectrometer in how they produce a spectrum. The grating disperses the light into a pattern that is linear in wavelength. For spectroscopies that are X, Y paired as wavelength and intensity a grating works well, though they still require a calibration against standards to map the spectrum in pixel space, as with a multichannel detector with pixel elements. For spectroscopies like Raman spectroscopy which are X, Y paired by frequency (cm⁻¹) and intensity, where cm⁻¹ is the accepted unit for frequency, a grating's linear pattern in wavelength can create calibration problems. For example, a Raman spectrum acquired with a 633 nm laser will not match a spectrum acquired with a 532 nm laser when plotted in wavelength. Raman spectra need to be X, Y paired as wavenumbers (cm⁻¹) and intensity to produce the same energy difference spectra irrespective of the laser excitation wavelength. Unlike the simple calibration to map pixel number from a multichannel detector to wavelengths in a grating system, the relationship between wavelengths and wavenumbers is an inverse relationship where cm⁻¹=1/cm and cm is equivalent to the wavelength. This means that a simple (linear) map between pixels and wavenumbers is not possible with a grating spectrometer. The accepted method is ASTM E 1840 to calibrate Raman spectra with a grating spectrometer. This ASTM method requires matching peaks in the uncalibrated pixel space with the peaks provided by ASTM as acceptable Raman standard peaks. Rather than a linear mapping the 1/wavelength relationship requires high ordered least square fits to find the appropriate mapping. This method also requires at least one chemical standard to be used frequently to ensure proper calibration and the ASTM standards typically have toxicity and often have volatility associated with them. An implementation of the methods for correcting for mirror motion and other environmental changes can eliminate these problems and can produce an improved calibration for every spectrum.

Calibration within a spectrometer and between spectrometers is often important for applications that correlate acquired spectra against a standard library. The complex and often poor calibration of grating spectrometers leads to poor matching against standard libraries. Another use of spectroscopic data is with large data sets used to create machine learning models. In these machine learning tools it is again important to have calibrations adequate to create meaningful robust models.

Yet another complication of grating spectrometers with multichannel detectors is the intensity calibration. As with the mapping of pixels to wavenumbers the consistency of intensity at each wavenumber is important to matching libraries with standard intensities for peaks or for machine learning models. The grating spectrometer disperses the light into a pattern of wavelengths and their intensities that is orthogonal to the direction of the light. A multichannel detector is placed along this orthogonal axis to create a digital spectrum. The problem is that the dispersed light must be focused along this axis and the optics for focusing must be significantly larger than the grating or, if small focusing optics are used, a pattern with vignetting will be created. The large optics limit the small size achievable with this type of system and the vignetting creates an inconsistent spread of intensities across the multichannel detector. This is an advantage for FT spectrometers which have a single detector and are not subject to the size requirements of the lens to focus onto a multichannel array detector.

FIGS. 11A through 11C show data from an interferogram produced by multiple sawtooth waves leading to 15 interferograms composed of forward and reverse mirror motion. FIG. 11A shows corrected, but not calibrated data along a plurality of datapoints. FIG. 11B shows 15 individual (some of which are at least partially overlapping) corresponding laser lines for the data shown in FIG. 11A. FIG. 11C shows a zoomed-in view of a region of the data shown in FIG. 11A in the region from 1100 to 900 cm⁻¹ uncalibrated data. A segregation of metrology laser signals can be seen due to the speed difference of the motor moving in the forward and backward direction. It can also be seen that even within these two subsets there is variation between scans. This is an artifact produced by poor mirror motion in a small scalable FT spectrometer. This is after application of the correction algorithm described in FIG. 5. This represents a new problem of calibration. The different mirror speeds within a forward or reverse direction waveform and the even larger speed difference between forward and reverse leads to different frequencies for the laser and Raman signals in the FT spectrum. By post-processing as described in FIG. 5 one can correct the data as shown in FIG. 11A and apply the FT algorithm to each interferogram produced by the forward and reverse directions of multiple sawtooth patterns. Each of these subsets of data from the sawtooth will have its unique laser line frequency and Raman spectrum. Since Raman scattering is an inelastic scattering or, in other words, energy loss, the individual subsets can be calibrated to achieve an improved calibration and multiple subsets from a sawtooth wave pattern can be averaged precisely.

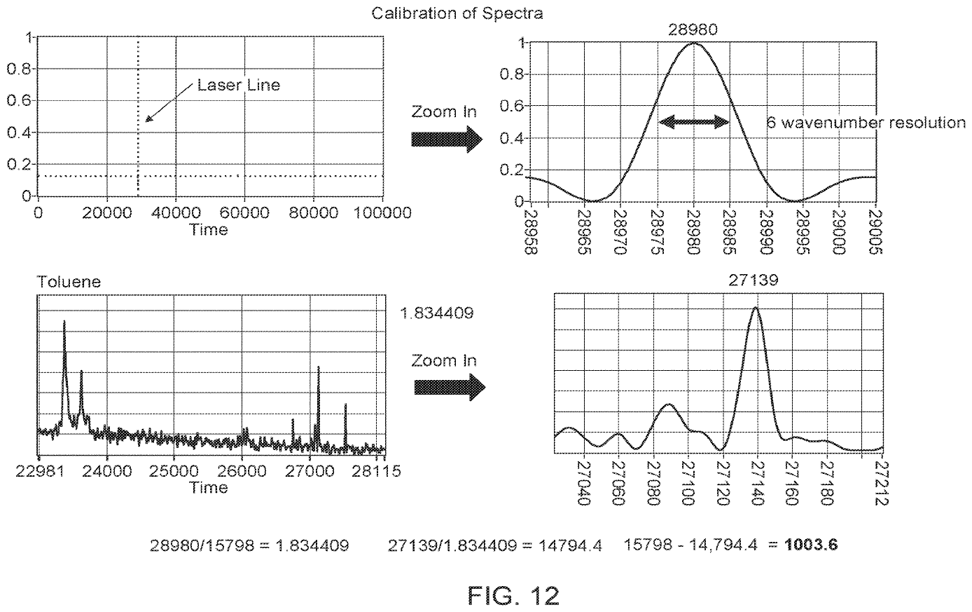

FIG. 12 shows an example of calibration with a scalable FT spectrometer.

The FT spectra shown on the graph on the left-hand side of FIG. 12 are uncalibrated data from the metrology detector (top) and the spectroscopy detector (bottom). These were acquired with a 633 nm laser, with the spectrometer configuration shown in FIG. 2. In this implementation the Raman laser and metrology laser are the same source. The sample is toluene. Toluene is characterized by a large peak located at 1003.6 cm⁻¹ (reported in ASTM E 1840). In the top left it is shown that the laser line at 15798 cm⁻¹ occurs at the arbitrary data point of 28980 in the FT spectrum. Unlike a grating spectrometer which requires nonlinear mapping, it can be seen that the map in this case is a linear map with the linear coefficient of 1.834409. This is calculated by 28980/157898=1.834409. When this mapping coefficient is applied to the data from the spectroscopy detector, the peak of toluene is found to be 14794.4 cm⁻¹. Since Raman spectroscopy is energy lost from the laser energy the energy of the toluene peak is 15798−14794.4=1003.6 cm⁻¹.

This implementation combined with the implementation described by FIG. 5 pairs the normalized intensities with the calibrated wavenumber location. This is useful for a robust scalable FT spectrometer that may be used for correlation with libraries or with machine learning models.

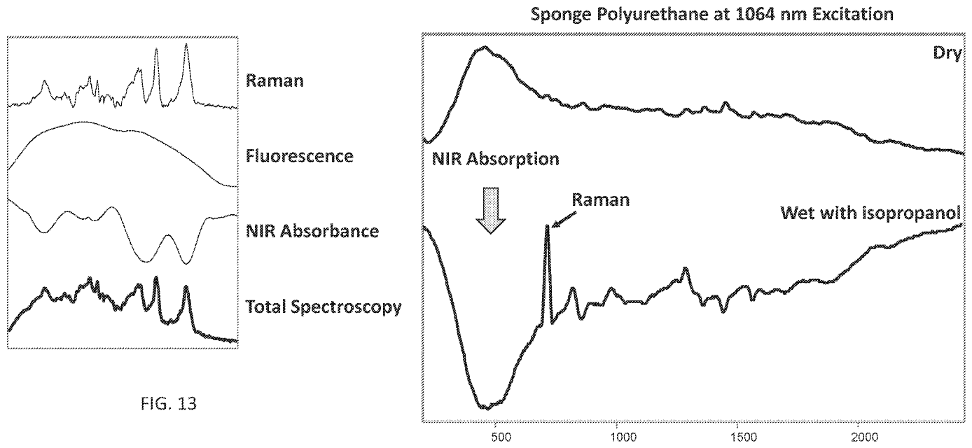

FIG. 13 is an example of combinations of multiple spectroscopic signals.

The science of spectroscopy almost exclusively uses one technique to solve a problem or multiple applications of different techniques individually to solve a problem. For example, a book on analytical spectroscopy will have chapters designated to the different types of spectroscopy. Our implementation of scalable FT spectroscopy enables a method to perform three different spectroscopic methods simultaneously. Depending on the sample, excitation with a laser can produce Raman scattering only or a combination of Raman scattering and fluorescence from the sample or impurities within the sample. Both Raman scattering and fluorescence can be considered spectroscopic information. In addition to Raman scattering and fluorescence there is a third technique that can provide critical information about a sample. Light can be absorbed by the sample, in fact, if fluorescence is present, it is due to absorption of the laser excitation and emission of the fluorescence signal. Fluorescence signals are broad, often representing a continuous background over the whole Raman spectrum. In addition to electronic absorption of light there is an absorption due to vibrations of molecules within the sample. The fundamental wavelengths for the absorption of light that causes molecules to vibrate are 2500 to 50000 nm. These wavelengths are beyond range of emission produced by fluorescence or Raman scattering. These constitute the technique known as IR Absorption spectroscopy or when combined with FT it becomes FTIR. Besides the fundamental vibrations of molecules there are overtones that range from 700 nm to 2500 nm. The spectroscopic technique that measures these overtones is termed NIR Absorption spectroscopy. Raman spectroscopy is commonly performed in this region of the spectrum. Judicious choice of the laser excitation wavelength to produce fluorescence and to be in this wavelength range will permit Raman scattering, fluorescence, and NIR absorbance to be observed simultaneously. These three sources of information from a single FT spectrometer will enhance its spectra for building machine learning models and for precise correlations to existing libraries.

The left-hand side of FIG. 13 is a conceptualization of what we term the “Total Spectroscopy” or a combination of Raman scattering, fluorescence, and NIR absorption. At the top is the Raman scattering from the sample, second from the top is the fluorescence, third from the top are NIR absorbances from the sample, and the bottom is the combination “Total Spectroscopy” signal that would be observed. Extraction of these three is possible by observing the rate of change in the signal across the spectrum. This technique is similar to Sequential Excitation Raman Difference Spectroscopy (SERD). If the fluorescence spectrum is standard and is in a library, it can be compared to the result from SERDS to produce the NIR absorption spectrum. While this may be possible, it is not standard to have fluorescence libraries.

In one implementation of a spectrometer, the total detected spectrum may be used without separation into Raman scattering, fluorescence, and NIR absorbance to build heuristic models around desired properties of the sample. For example, measurement from a wearable device or small device to gather the total spectrum and to build models around characteristics such as nutrition or hydration levels.

In one embodiment, for example, a Total Spectroscopy method may comprise the following:
Excite a sample using at least one light source, such as using a laser light source to produce a Total Spectroscopy signal comprising Raman scattering, fluorescence, and absorption components. In another embodiment, the at least one light source may comprise a laser light source used to produce Raman scattering and fluorescence, and a relatively weak broadband source to produce an absorption component.
obtain a total spectroscopy signal comprising at least a Raman spectroscopic component, a fluorescence spectroscopic component, and an NIR absorption component forming an integrated total spectroscopy signal;
compare the total spectroscopy signal to a library of discrete total spectroscopy signals and respective corresponding materials and/or compare the total spectroscopy signal to a standard intensity or absorption to produce a quantitative response; and
identify at least one of the corresponding qualitative or quantitative response based on the total spectroscopy signal.

In another embodiment, a training set of total spectroscopy signals are acquired and run through a machine learning algorithm to build a model for comparing a detected total spectroscopy signal to identify materials or a quantitative response.

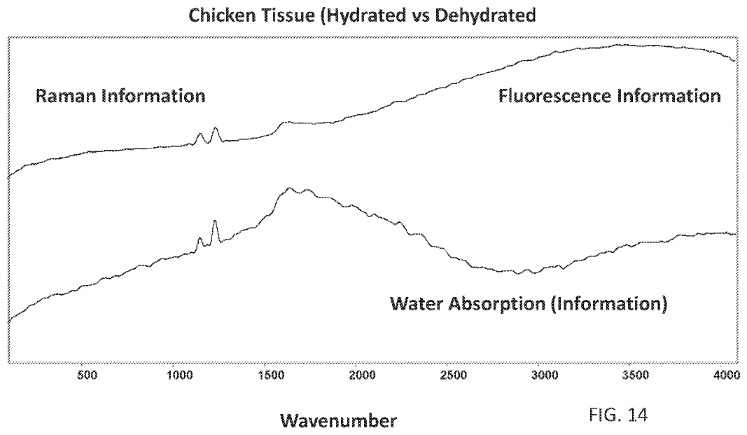

FIG. 14 is another example of an FT spectrometer adapted to produce a Total Spectroscopy signal that is a combination of at least a Raman spectrum, a fluorescence spectrum, and a NIR absorption spectrum.

In this example, the Total Spectroscopy signal is used to determine a measurement of hydration levels of tissues in-vivo. For example, high levels of hydration can be indicative of oedema which is a serious indicator of cardiovascular disease. Low hydration levels can be indicative of dehydration which is a serious condition indicative of several diseases and excessive exercise and heat that could lead to death.

FIG. 14 shows the Total Spectroscopy spectra of chicken tissue in its naturally hydrated state (bottom spectra) and after dehydration (top spectra). These spectra were collected with an FT spectrometer operating with a 1064 nm excitation source. At this wavelength animal tissue produces Raman scattering, fluorescence, and NIR absorbance. While the NIR absorbance stems from many components of the tissue, a large absorption component comes from water. Water is strongly absorbed in this region of the spectrum. Raman spectra of water are weak, making this combination orthogonal with respect to their information content. Orthogonal is used in this context to mean the two methods that produce different information.

FIGS. 15A through 15D show an example of an implementation of VCSEL excitation to produce spatial information about a sample.

One of the characteristics of dispersive spectrometers is the requirement to pass the signal through an aperture which determines the spectral resolution of the spectrometer. The requirement does not exist for FT spectrometers, and it is termed in literature as Jacquinot's advantage. In one implementation, an FT spectrometer may use a VCSEL array spectroscopic light source. In this example, the VCSEL array spectroscopic light source enables two implementations for a scalable FT spectrometer. First, the arrays can be used to produce a large area of excitation which through Jacquinot's advantage will be allowed in its entirety into an interferometer. This means that the power density on the sample can be small compared to dispersive systems which require a small focal point at the sample to pass through its aperture to produce a spectrum. Second, the elements of the VCSEL array can be individually addressable to illuminate different points of the sample.

Lowering the power density at a sample through this implementation of a laser or VCSEL array is critical when sampling human tissues in-vivo. The intensity of light allowed on a human tissue is defined through the Maximum Permissible Exposure (MPE). To develop a regulatory acceptable FT spectrometer for wearable or in general, in-vivo spectroscopic analysis the MPE dictates the laser power, which for a focused beam in a dispersive spectrometer can be impossibly low. Whereas the Jacquinot advantage coupled with laser or VCSEL arrays can make high laser intensities possible due the large area of excitation.

The ability to individually address the elements of a VCSEL array spectroscopic light source enables the sample's spatial distribution to be analyzed. This also would enable a large area of the sample to be averaged with a lower power density. The implementation of sampling the distribution of molecules in a sample is shown in FIGS. 15A through 15D. FIG. 15A shows a VCSEL array spectroscopic light source with all elements turned on in which case this implementation would produce a spectrum (shown in FIG. 15D as Spectrum A) with a low power density and an average of the spatial distribution of materials. FIG. 15B shows a VCSEL array spectroscopic light source with only one half of its lasers turned on and the resulting spectrum which is a subset of the average. This spectrum shown in FIG. 15D as Spectrum B is different from that shown in FIG. 15A as shown in the highlight rectangle around the 1000 wavenumber region. FIG. 15C shows the VSEL array spectroscopic light source with the other half of the array turned on and the resulting spectrum shown in FIG. 15D as Spectrum C, which is different from the spectra Spectrum A and Spectrum B corresponding to FIGS. 15A and 15B. This shows how a sample's spatial distribution can be determined. The example of one half of the array on at a time is only one implementation of the laser or VCSEL array spectroscopic light source, it could be only one element on at a time up to all elements but one on at time. Regardless, the spatial pattern of the VCSEL array spectroscopic light source could correlated with the resulting spectra to produce a spatial map of the sample. An example application would be the distribution of components in a pharmaceutical mixture. Another example application would be the distribution of illicit materials in a sample, where matching to individual components could lead to more accurate identification from a spectral library rather than the average over the sample.

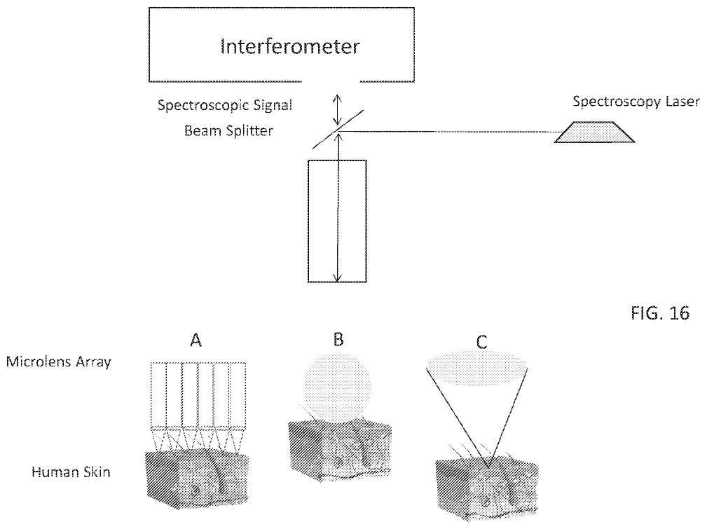

FIG. 16 is another example of an implementation of an FT spectrometer comprising a relatively large area excitation pattern adapted to produce spatial averaging and lower power density over the sample.

As described with respect to FIGS. 15A through 15C, the amount of laser power that can be used in spectroscopic analysis in-vivo is strictly regulated by the MPE. FIG. 16 shows a method to achieve lower power density and an average over a large area of the sample using either a VCSEL type laser or other types of lasers. In this example a comparison of 3 possible sampling configurations is shown: a microlens array, a ball lens, and a lens to focus the laser from a distance to the sample. If the ball lens or the lens were to focus a 100 mW laser onto the sample the power density from, for example, a 50 micron focal point would be 50 W/mm². This situation would also lead to a small spatial average by the 50-micron spot of the sample. The implementation of a lens array of 10×10 mm with the same 100 mW laser would produce a power density of 0.001 W/mm². This is a 50,000-fold decrease in the power density which would mean a 50,000 fold increase in the probability of not exceeding the MPE. It would also improve the averaging of the sample. The application illustrated is sampling of tissue in-vivo where the sample is very complex and spatial varies greater than a 50-micron spot.

A microlens array (or other lens array) could be used with a spectroscopic light source array, such as a VCSEL array spectroscopic light source, with one or more individual lens elements corresponding to one or more individual light source elements or may be used with a single light source element, such as a single light source element passed through a beam expander onto the lens array.

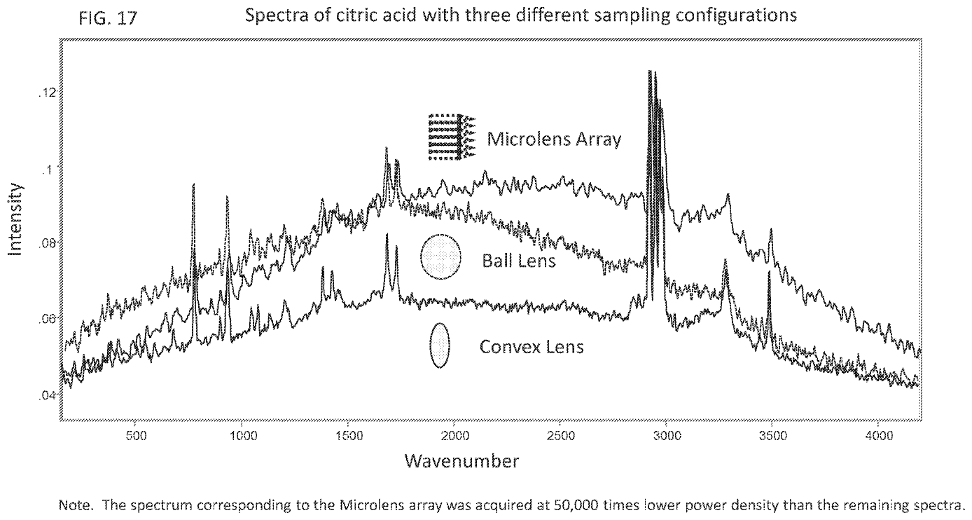

FIG. 17 is an example of an implementation of a microlens array to produce a Raman spectrum.

FIG. 17 shows data from the three sampling configurations discussed in FIG. 16. The sample is citric acid, a poor Raman scatterer, and the laser power is 30 mW at 633 nm. All of these spectra were collected with a FT-Raman spectrometer. The significance of these spectra is that they are nearly equivalent in signal, yet as calculated in FIG. 17 the power density from the microlens array is 50,000-fold less.

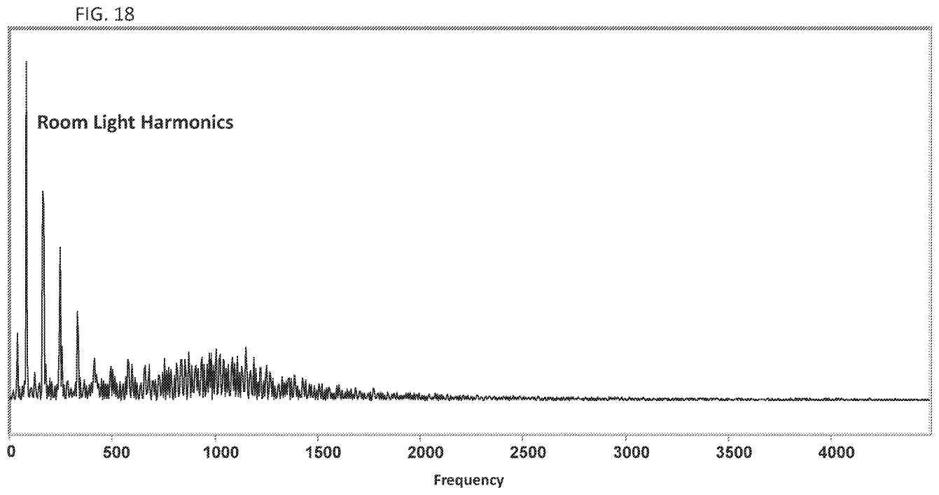

FIG. 18 is an example of an implementation of a scalable FT spectrometer for rejection of interferences from ambient light conditions.

An interference for Raman spectroscopy is non-Raman scattering contributions to the spectrum. These can be either created by competing light sources, such as by room lights or by solar radiation. A dispersive multichannel spectrometer acquired over a time period in which room lights are operating at 50 or 60 Hz are averaged into the Raman signal. Likewise solar radiation can fluctuates naturally at a low frequency due to clouds and natural fluctuations and at higher frequencies from turbulence, dust, atmospheric temperature changes. Dispersive spectrometers which average over light within the spectrometer's spectral window cannot distinguish between the source of the interference. FT spectroscopy detects light interferences and converts it into frequency components.

In one implementation of an FT spectrometer, the FT spectrometer is adapted to distinguish the source of light detected by the FT spectrometer. This is valuable to reject ambient and solar interferences.

FIG. 18 shows a spectrum produced by an FT spectrometer over a large range of frequencies. This shows an implementation of FT spectroscopy used to reject ambient room lights which are at a much lower frequency than optical frequencies. Low frequency and high frequency variations in solar radiation would also be rejected. For example, the ability to distinguish the spectroscopic signals from interfering ambient light conditions is useful for a wearable device worn under differ ambient light conditions. Another example would be an FT spectrometer operating in different ambient light conditions to detect and identify materials.

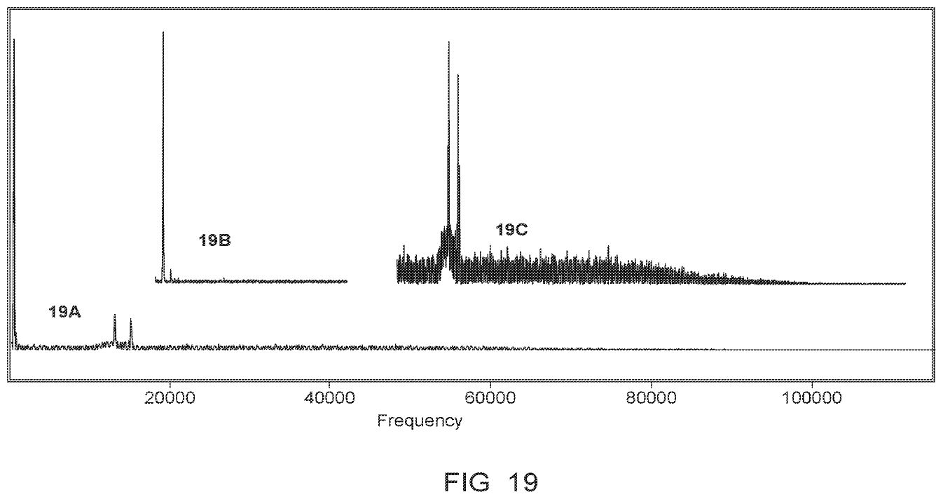

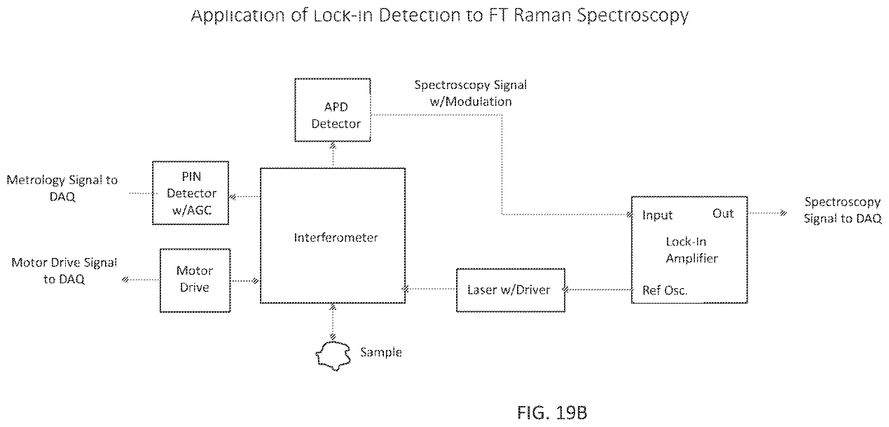

FIG. 19 shows another example implementation of a scalable FT spectrometer for rejection of interferences.

Spectrum 19A shown in FIG. 19 shows a full FT spectrum of toluene acquired with 30 mW of 633 nm light. The frequency axis is determined in part by the rate at which the mirror is moving. The Spectrum 19A contains three important regions. First, at low frequencies the room light interference is observed. Second, in the 10 kHz to 20 kHz region the Raman signal is observed. Thirdly, at high frequency (above ~80 kHz) the noise drops off. The first region, enhanced in Spectrum 19B, is the implementation discussed in FIG. 18, it is the separation of room lights flickering due to the AC voltage from the Raman signal. Spectrum 19C enhances the Raman spectral frequencies and noise drop-off. FIG. 19C leads to a further innovation to use a lock-in amplifier to collect frequency modulated signals from a modulated laser source. This has been found to increase the signal to noise by ~2 for the 633 nm laser and a Si photodiode. Since one of the noise sources is thermal noise from the dark current and it is low frequency, the rejection by modulating the laser at high frequency and detecting only light at these higher frequency through the lock-in amplifier improves the signal to noise.

FIG. 19B is a block diagram showing an example embodiment of a lock-in amplifier that may be used in an FT spectrometer to collect frequency modulated signals from a modulated laser source.

One effective way to recover the small signal buried by large ambient noise is to use the so-called phase sensitive detector, or lock-in amplifier. A phase sensitive detector achieves narrow bandwidth amplification by reducing the noise content falling outside the bandwidth of interest.

When the noise is white in nature, we can reduce its level of magnitude dramatically by limiting the bandwidth of detection, which includes the modulation frequency occurring to the signal while excludes the frequencies occurring to the noise. Phase sensitive detection enables extremely narrow bandwidth detection (0.001 Hz is normal). Typical application scenario is using electric transducers where the amplitude of noise is in milli Volts and the signal falls into nano Volt region.

FT Raman spectroscopy is challenging due to the low optical signal generated which is on the order of 0.3 nA for laser power of 500 mW. This nearly equal to the dark current of a silicon sensor used for visible wavelengths and about an order of magnitude less than the dark current of an InGaAs sensor used for NIR wavelengths. Other sources of noise in the system are the Johnson noise of the sensor load resistor and the noise generated by the preamplifier op-amp. All of these noise sources are of an amplitude similar to or larger than the desired signal and they are broadband so they will be present in the interferogram regardless of the frequency of the interference pattern, which is controlled by the mirror velocity. Total noise power is proportional to the detector bandwidth which implies the narrowing the bandwidth will reduce the power density in the signal as long as the signal is not correspondingly attenuated. The use of a phase sensitive detector, AKA a lock-in amplifier allows the system to reduce the effective bandwidth to a fraction of a Hertz while maintaining full power in the signal of interest. It achieves this by modulating the signal source (laser) at a controlled frequency and phase and then multiplying the received signal by the reference used to modulate the source. This result is low-pass filtered to remove the modulation frequency and then passed on the data acquisition portion of the system. This allows high SNR to be achieved even when the broadband noise in the system is greater than the desired interferogram signal.

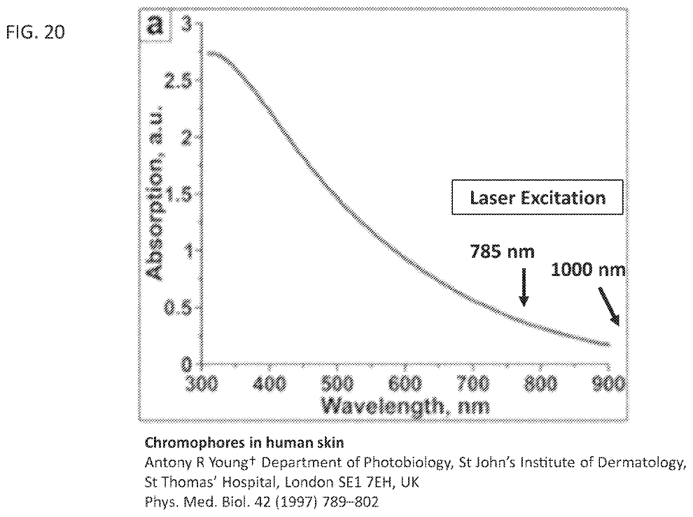

FIG. 20 is another example of an implementation of a device to operate at long wavelengths above 900 nm.

Skin pigmentation commonly has two sources: race and exposure to sunlight. One implementation of our scalable FT spectrometer is in-vivo measurements through the skin to monitor one's health state. FIG. 20 shows the absorption of chromophores (pigment) as a function of wavelength. As expected, it is very high at dangerous UV wavelengths and drops off at harmless longer wavelengths. Laser excitation and spectroscopy at longer than ~800 nm wavelengths would decrease the signal losses in people of color and decrease the variations in signal due to sun related pigmentation.

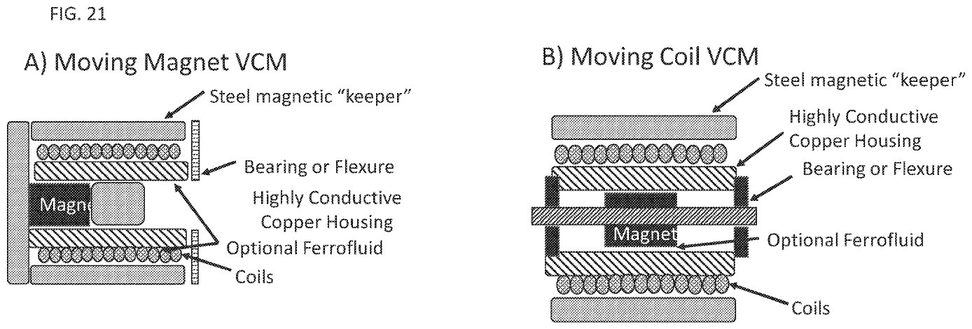

FIG. 21 shows two example implementations of actuators that may be used to move a component of an FT spectrometer, such as a moving mirror of an interferometer of an FT spectrometer. FIG. 21, for example shows a moving magnet voice coil motor embodiment that may be used as an actuator within an FT spectrometer. In this embodiment, a magnet is disposed between a set of coils within a conductive housing (e.g., copper).
to produce scalable FT spectrometers.

Shape-Memory Alloy (SMA) materials will contract up to 7% in length when heated beyond their transition temperature while providing significant motive force. The materials are available in a variety of transition temperatures ranging from −20 C to 100 C with 70 C and 90 C being typical values. This heating can be provided by an outside heating source or, more commonly, a current is passed through the wire resulting in Joule heating.

The actuator SMA material may be a wire or ribbon form and it may consist of multiple elements that are in parallel mechanically. The use of smaller, thinner elements in parallel has the benefit of heating and cooling more quickly and therefore providing faster motion.

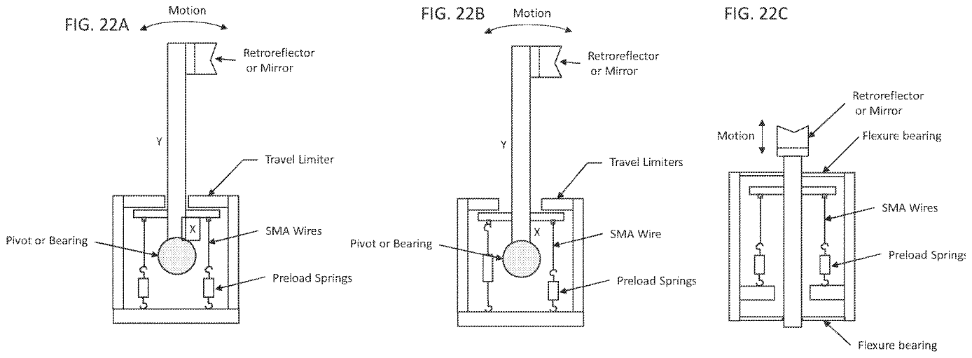

FIG. 22A shows a bidirectional drive Shape Memory Alloy (SMA) rotational actuator.

Left and right hand SMA wires are alternately heated by passing current through them. This allows for symmetric velocity in both directions rather than waiting for the wire to cool by dissipating heat to the ambient air. Mechanical amplification is provided by placing the anchor points for the SMA elements closer to the pivot than the mirror. For a typical application a ratio of Y to X may be anywhere from 2 to 20. This allows the design to be compact with an SMA length of as little as 1 cm.

FIG. 22B shows a monodirectional drive Shape Memory Alloy (SMA) rotational actuator.

The right hand SMA wire is heated by passing current through it to provide clockwise motion of the mirror. Counterclockwise motion is provided as the wire cools which typically takes twice as long as heating. This design is best suited to taking the interferogram in only one direction due to the large difference in velocity depending on direction.

FIG. 22C shows a Shape Memory Alloy (SMA) Linear actuator.

The wires are heated by the applied current to provide motion toward the device while return motion is provided by the spring constant of the flexure bearings. A symmetrical version can also be created by having a second set of wires pulling opposite to those shown and by alternating the current between the wire pairs. The linear actuator does not provide any mechanical amplification which results in a larger size. For an application requiring 0.6 mm of motion the SMA elements would need to be 6 cm in length.

### Piezoelectric Actuators

Piezoelectric actuators provide high force, high speed, and good control with a stroke of 40 to 120 μm. The PowerHap series from TDK/Epcos are representative of the mechanically amplified piezo actuators that are potentially useful for providing mirror motion in an interferometer.

Mechanical amplification is provided by placing the thrust point for the piezoelectric actuator closer to the pivot than the mirror. For a typical application a ratio of Y to X may be anywhere from 5 to 20.

FIG. 22A shows a square amplified piezoelectric actuator.

Based on a 12.7 mm square actuator the preload would be 2N and the mechanical amplification ratio of Y to X would be 15:1 to provide 0.6 mm of mirror travel with 40 μm of actuator stroke.

The drive necessary is 120 V at very low current is needed for full range of motion and a small negative voltage will be applied to overcome the hysteresis inherent in the piezo ceramic element.

FIG. 22B shows a rectangular amplified piezoelectric actuator.

Based on a 60 mm×5 mm rectangular actuator the preload would be 15N and the mechanical amplification ratio of Y to X would be 5:1 to provide 0.6 mm of mirror travel with 120 μm of actuator stroke. This design is larger but will have the benefit of being much more mechanically rigid with respect to perturbations of the rotating arm and mirror.

A 120 V drive is necessary and very low current is needed for full range of motion and a small negative voltage will be applied to overcome the hysteresis inherent in the piezo ceramic element.

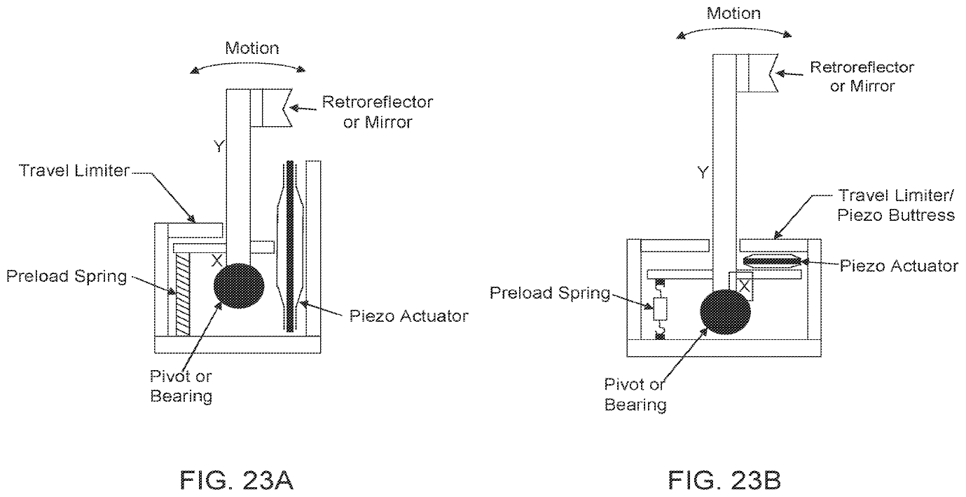

To produce good quality data from a Michelson interferometer it is helpful to move one of the mirrors in a smooth, continuous fashion. One method to provide this motion is the use of a linear or rotating Voice Coil Motor (VCM) which comprises one or more coil windings, a support structure, and a permanent magnet. The motor can be configured such that either the coil moves, or the magnet moves. Since movement of the VCM in an interferometer is relatively slow (<20 Hz) there is little efficiency penalty accrued by use of mechanical dampening. However, such dampening should be achieved in a manner that does not cause any jerkiness in the motion. To achieve that, we propose using a highly conductive metal layer that will generate back EMF that will dampen the motion. The dampening can be achieved by making the coil from copper or another highly conductive material which will then generate back EMF forces whenever the coil is moving. Another means of achieving this dampening, which can be used in combination with eddy current dampening, is the use of ferrofluid inside of the VCM. In particular, a high viscosity ferrofluid will provide dampening while also providing smooth motion. These are illustrated as a Moving Magnet VCM and a Moving Coil VCM below, FIGS. 23A and 23B, respectively.

What is claimed is:

1. A Fourier Transform (FT) spectrometer comprising:
an excitation light source adapted to provide an excitation light signal;
a spectrometer beam splitter adapted to:
receive the excitation light signal from the excitation light source,
separate the excitation light signal into a first spectroscopic excitation portion and a second metrology portion of the excitation light signal,
direct the first spectroscopic excitation portion toward a sample and the second metrology portion of the excitation light signal toward a metrology mirror,
wherein the metrology mirror is adapted to reflect the second metrology portion of the excitation light signal and the spectrometer beam splitter is adapted to reflect the second metrology portion of the excitation light signal received from the metrology mirror and pass a spectroscopy signal received from the sample;
an interferometer comprising:
an interferometer beam splitter adapted to receive a respective one of the reflected metrology portion of the excitation light signal and the spectroscopy signal and split the respective one of the reflected metrology portion of the excitation light signal and the spectroscopy signal between a first mirror, and a second mirror, and to direct reflected signals from the first and second mirrors from the interferometer;
a first metrology signal detector;
a second spectroscopic signal detector; and
a second spectrometer beam splitter adapted to direct the second metrology portion of the excitation signal toward the first metrology signal detector and to direct the spectroscopy signal signal to the second spectroscopic signal detector.

2. The FT spectrometer of claim 1, wherein the metrology mirror is adapted to attenuate the second metrology portion of the excitation light signal.

3. The FT spectrometer of claim 1, wherein a filter is adapted to attenuate the second metrology portion of the excitation light signal.

4. The FT spectrometer of claim 3, wherein the filter is disposed between the metrology mirror and the spectrometer beam splitter or between the second spectrometer beam splitter and the first metrology signal detector.

5. The FT spectrometer of claim 1, wherein a controller is adapted to perform a Fourier Transform on a metrology output of the first metrology detector and on a spectroscopy signal output of the second spectroscopic detector.

6. The FT spectrometer of claim 1, wherein a controller is adapted to perform the following operations:
determine a number of peaks in a metrology signal interferogram;
determine an average frequency of peaks in the metrology signal interferogram based on the number of peaks;
generate a theoretical interferogram with a sinusoidal pattern based on the frequency;
locate a plurality of data points in metrology signal interferogram and in the theoretical interferogram; and
adjust a plurality of distances corresponding to the plurality of data points in the metrology signal interferogram to match the theoretical interferogram.

7. The FT spectrometer of claim 6, wherein the plurality of adjusted distances corresponding to the plurality of data points of the metrology signal interferogram to map a spectroscopic interferogram to the theoretical interferogram to correct the spectrogram interferogram.

8. The FT Spectrometer of claim 1 wherein the spectrometer is adapted to collect a total spectroscopy signal comprising a Raman scattering component, a fluorescence component, and a near infrared (NIR) absorption component.

9. The FT Spectrometer of claim 8 wherein the total spectroscopy is compared to a library or a machine learning model.

10. A method of providing a Fourier Transform (FT) spectroscopy comprising;
providing an excitation light signal;
separating the excitation light signal into a first spectroscopic excitation portion and a second metrology portion;
directing the first spectroscopic excitation portion of the excitation light signal toward a sample;
directing the second metrology portion of the excitation light signal toward an interferometer beam splitter;
separating the second metrology portion of the excitation light between a first interferometer mirror and a second interferometer mirror;
moving at least one of the first and second interferometer mirrors to generate an interference pattern between the separated portions of the second metrology portion of the excitation light signal;
directing reflected portions of the metrology portion of the excitation light signal from the first interferometer mirror and the second interferometer mirror toward a first metrology detector;
separating the spectroscopy signal between the first interferometer mirror and the second interferometer mirror;
moving at least one of the first and second interferometer mirrors to generate an interference pattern between the separated portions of the spectroscopy signal; and
directing reflected portions of the spectroscopy signal from the first interferometer mirror and the second interferometer mirror toward a second spectroscopic detector.

11. The method of claim 10, wherein the metrology mirror is adapted to attenuate the second metrology portion of the excitation light signal.

12. The method of claim 10, wherein a filter is adapted to attenuate the second metrology portion of the excitation light signal.

13. The FT spectrometer of claim 12, wherein the filter is disposed between the metrology mirror and the spectrometer beam splitter or between the second spectrometer beam splitter and the first metrology signal detector.

14. The method of claim 10, wherein a controller is adapted to perform a Fourier Transform on a metrology output of the first metrology detector and on a spectroscopy signal output of the second spectroscopic detector.

15. The method of claim 10, wherein a controller is adapted to perform the following operations:
determine a number of peaks in a metrology signal interferogram;
determine an average frequency of peaks in the metrology signal interferogram based on the number of peaks;
generate a theoretical interferogram with a sinusoidal pattern based on the frequency;
locate a plurality of data points in metrology signal interferogram and in the theoretical interferogram; and
adjust a plurality of distances corresponding to the plurality of data points in the metrology signal interferogram to match the theoretical interferogram; and

16. The method of claim 15, wherein the plurality of adjusted distances corresponding to the plurality of data points of the metrology signal interferogram to map a spectroscopic interferogram to the theoretical interferogram to correct the spectrogram interferogram.

17. The method of claim 10 wherein the spectrometer is adapted to collect a total spectroscopy signal comprising a Raman scattering component, a fluorescence component, and a near infrared (NIR) absorption component.

18. The method of claim 8 wherein the total spectroscopy is compared to a library or a machine learning model.

19. A method of correcting a signal from an interferometer of an FT Spectrometer comprising:
determine a number of peaks in a metrology signal interferogram;
determine an average frequency of peaks in the metrology signal interferogram based on the number of peaks;
generate a theoretical interferogram with a sinusoidal pattern based on the frequency;
locate a plurality of data points in metrology signal interferogram and in the theoretical interferogram; and
adjust a plurality of distances corresponding to the plurality of data points in the metrology signal interferogram to match the theoretical interferogram; and

20. The FT spectrometer of claim 6, wherein the plurality of adjusted distances corresponding to the plurality of data points of the metrology signal interferogram to map a spectroscopic interferogram to the theoretical interferogram to correct the spectrogram interferogram.

21. A Total Spectroscopy method comprising:
Excite a sample using at least one light source, such as using a laser light source to produce a Total Spectroscopy signal comprising Raman scattering, fluorescence, and absorption components. In another embodiment, the at least one light source may comprise a laser light source used to produce Raman scattering and fluorescence, and a relatively weak broadband source to produce an absorption component.
obtain a total spectroscopy signal comprising at least a Raman spectroscopic component, a fluorescence spectroscopic component, and an NIR absorption component forming an integrated total spectroscopy signal;
compare the total spectroscopy signal to a library of discrete total spectroscopy signals and respective corresponding materials and/or compare the total spectroscopy signal to a standard intensity or absorption to produce a quantitative response; and
identify at least one of the corresponding qualitative or quantitative response based on the total spectroscopy signal.

22. The method of claim 21 wherein a training set of total spectroscopy signals are acquired and run through a machine learning algorithm to build a model for comparing a detected total spectroscopy signal to identify materials or a quantitative response
